(19) United States
(12) Patent Application Publication
(10) Pub. No.: US 2011/0089159 A1
(43) Pub. Date: Apr. 21, 2011

(54) Heat pad assembly with positioning members

(76) Inventor: Shu-Lien Chen, Taichung (TW)

(21) Appl. No.: 12/588,464

(22) Filed: Oct. 16, 2009

(51) Int. Cl. H05B 3/34

(52) U.S. Cl. 219/528

(57) ABSTRACT

A heat pad assembly includes a pocket and a heat member is received in the pocket. Wires are connected between the controller and the heat member via a through hole defined through a layer of the pocket. The heat member is controlled by operation of the controller. Multiple positioning members are located at a back plate of the pocket and the positioning members are easily connected to and removed from the wearer's cloth.

### FIELD OF THE INVENTION

The present invention relates to a heat pad assembly, and more particularly, to a heat pad assembly with positioning members on its back plate so as to be easily positioned on clothes or removed from clothes.

### BACKGROUND OF THE INVENTION

A conventional way to keep warm is to wear clothes which are made by cotton, fibers or wool so as to keep the wearer's body temperature or to have better ventilation in different seasons. Generally, people wear thick or even heavy clothes in a cool day to reduce loss of body temperature. However, for those who have to work under low temperature, the thick and/or heavy clothes are not convenient for actions.

A heat vest or jacket known to the applicant includes multiple heat members which are secured within the layers of the vest or jacket and a battery and a controller are received in pockets of the vest or jacket. Wires are connected between the heat members and the battery and the controller so that the user can control the heat members by operation of the controller. A coat is need to be wore outside the heat vest or jacket so that the heat generated from the heat members can be kept and does not escape to outside.

However, the wires have to penetrate through the fabric of the vest or jacket to be connected between the heat members and the battery and the controller so that the users cannot remove the heat members from the vest or jacket when cleaning or washing the vest or jacket. Furthermore, humidity or moisture may be trapped in the interior of the vest or jacket and shorts the circuit of heat members.

Therefore, most users do not clear the heat vest or jacket and this obviously is one of the drawbacks of the conventional heat vests or jackets.

The present invention intends to provide a heat pad assembly which includes positioning members on its back plate and the positioning members are easily connected to clothes or removed from the clothes according practical needs.

### SUMMARY OF THE INVENTION

The present invention relates to a heat pad assembly which comprises a pocket and a heat member is received in the pocket. A through hole is defined through a layer of the pocket so that wires extend through the through hole and are connected between the controller and the heat member.

The primary object of the present invention is to provide a heat pad assembly which can be easily connected to the wearer's clothes and removed from the clothes. The heat pad assembly generates heat to keep the wearer warm and is removed from the clothes so that the clothes can be conveniently cleaned.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the heat pad assembly of the present invention;

FIG. 2 is a cross sectional view of the heat pad assembly of the present invention;

FIG. 3 is a perspective view to show the second embodiment of the positioning members of the heat pad assembly of the present invention, and

FIG. 4 is a perspective view to show the third embodiment of the positioning members of the heat pad assembly of the present invention.

### DETAILED DESCRIPTION OF THE PREFERRED EMBODIMENT

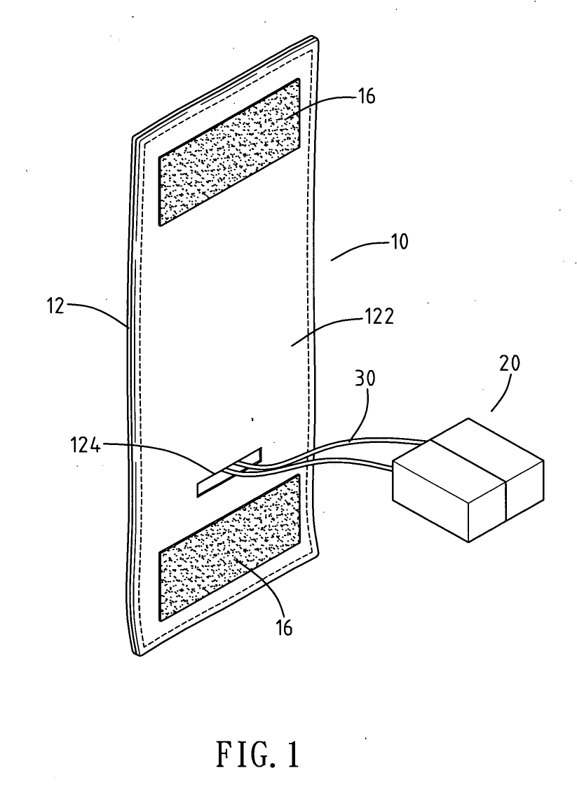

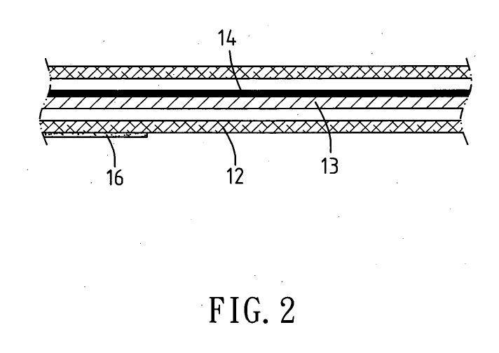

Referring to FIGS. 1 and 2, the heat pad assembly 10 of the present invention comprises a pocket 12 and a heat member 14 is received in the pocket 12. The pocket 12 is made of soft material which beats high temperature and a through hole 124 is defined through a layer of the pocket 12. The heat member 14 is thin and flexible and generates heat when being electrically powered. A controller 20 are connected with wires 30 which extend through the through hole 124 and are connected between the controller 20 and the heat member 14.

Multiple positioning members are located at a back plate 122 of the pocket 12 and the positioning members in this embodiment are hoop-loop members 16 which are easily attached to and removed from clothes. The number and shape of the positioning members can be varied according needs.

An isolation layer 13 is located between the heat member 14 and an inside of the pocket 12, and the isolation layer 13 is located adjacent to the back plate 122 so as to reduce loss of heat of the heat member 14.

The heat pad assembly 10 can be attached to the clothes at desired position by the positioning members and the user controls the controller 20 to adjust the temperature of the heat member 14 to provide warm temperature to the wear's body. It is noted that the heat pad assembly 10 can be easily removed from the clothes when the clothes are cleaned up.

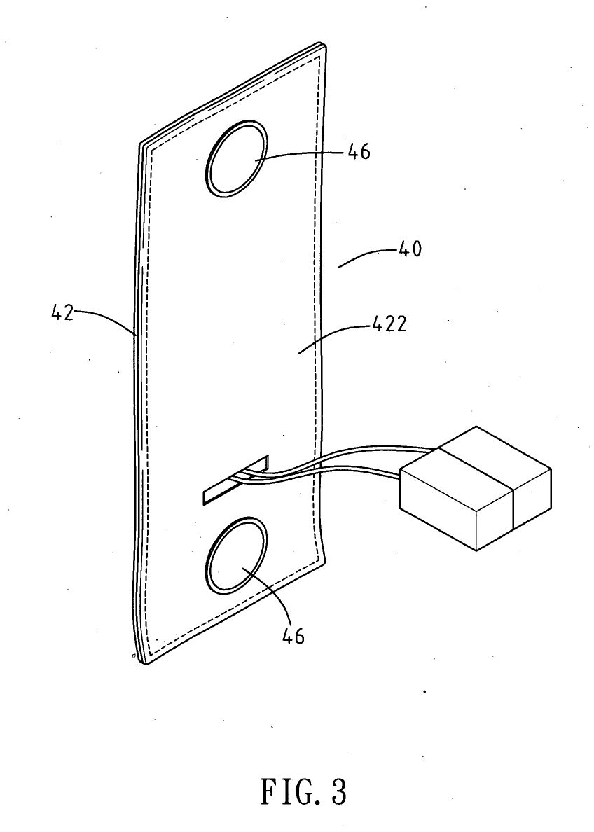

FIG. 3 shows the second embodiment of the present invention, wherein the only difference is the positioning members 46 which are connected to the back plate 422 of the pocket 42 of the heat pad assembly 40. The positioning members are male/female snap members 46 which are cooperated with female/male snap members (not shown) on the wearer's clothes. The heat pad assembly 40 is also conveniently and easily connected to the clothes or removed from the clothes.

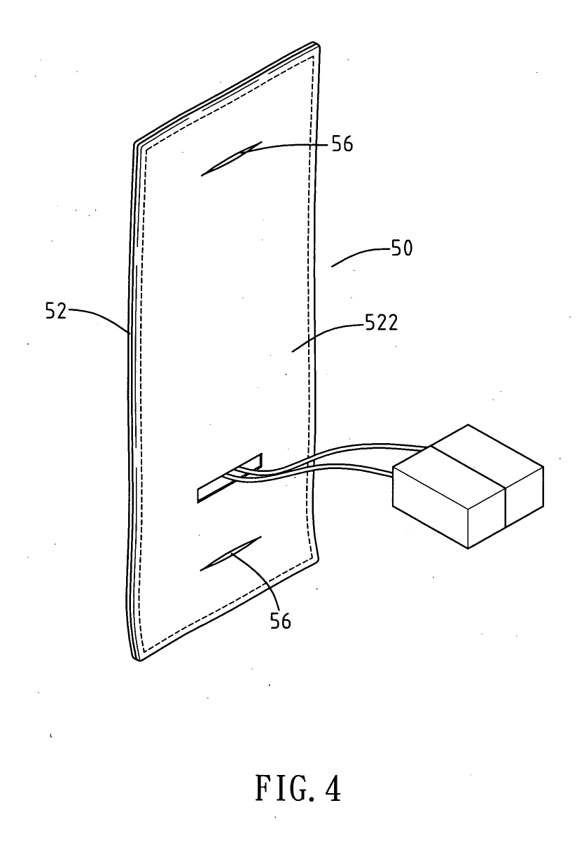

FIG. 4 shows the third embodiment of the present invention and the only difference is the positioning members which are button holes 56 defined through the back plate 522 of the pocket 52 of the heat pad assembly 50. The buttonholes 56 can be cooperated with buttons (not shown) on the, wearer's clothes. Again, the heat pad assembly 50 is also conveniently and easily connected to the clothes or removed from the clothes.

The heat pad assembly of the present invention improves the drawbacks of the conventional heat pad and allows the user to use at desired positions on the clothes. The heat pad assembly is easily removed from the clothes so that the clothes can be cleaned up by any known methods without worry of the heat pad assembly.

While we have shown and described the embodiment in accordance with the present invention, it should be clear to those skilled in the art that further embodiments may be made without departing from the scope of the present invention.

What is claimed is:

1. A heat pad assembly comprising:
a pocket and a heat member received in the pocket, a through hole defined through a layer of the pocket;
a controller having wires connected thereto and the wires extending through the through hole and connected between the controller and the heat member, and
multiple positioning members located at a back plate of the pocket.

2. The assembly as claimed in claim 1, wherein an isolation layer is located between the heat member and an inside of the pocket, the isolation layer is located adjacent to the back plate.

3. The assembly as claimed in claim 1, wherein the positioning members are hoop-loop members.

4. The assembly as claimed in claim 1, wherein the positioning members are snap members.

5. The assembly as claimed in claim 1, wherein the positioning members are button holes.
